(19) United States
(12) Patent Application Publication
(10) Pub. No.: US 2009/0052900 A1
(43) Pub. Date: Feb. 26, 2009

(54) MULTI-FUNCTION REMOTE CONTROLLER AND METHOD OF CONTROLLING THE SAME

(75) Inventor: Seung Pyo Hong, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/109,622

(22) Filed: Apr. 25, 2008

(30) Foreign Application Priority Data
Aug. 26, 2007 (KR) 2007-80169

(51) Int. Cl. H04B 10/00

(52) U.S. Cl. 398/111; 398/106; 398/112

(57) ABSTRACT

A multi-function remote controller includes a transmitter to transmit a wireless control signal corresponding to one selected from among a first mode via an infrared diode, in which a user manipulates the remote controller with one hand to manipulate a television, and a second mode, in which the user manipulates a video game unit with two hands. The transmitter turns a rotatable lever equipped with the infrared diode to set the first mode or the second mode according to a characteristic of an appliance to be controlled. The transmitter sets the remote controller in the first mode if a protrusion of the rotatable lever does not make contact with a mode selecting switch, and sets the remote controller in the second mode if the protrusion of the rotatable lever makes contact with the mode selecting switch due to the rotation of the rotatable lever, thereby simplifying components to set each mode using one hand or two hands.

### CROSS-REFERENCE TO RELATED APPLICATIONS

This application claims priority under 35 U.S.C 119(a) from Korean Patent Application No. 10-2007-0080169, filed on Aug. 9, 2007, in the Korean Intellectual Property Office, the disclosure of which is incorporated herein in its entirety by reference.

### BACKGROUND OF THE INVENTION

1. Field of the Invention

The present general inventive concept relates to a multi-function remote controller and a method of controlling the same, allowing a user to readily manipulate an appliance using one hand or two hands.

2. Description of the Related Art

Household appliances (e.g., television, optical disc player, multifunctional peripheral (MFP) equipped with functions of the television and optical disc player, etc.) typically include a remote controller used to transmit control commands to perform various functions.

A remote controller is equipped with a power on/off key and a plurality of functional keys to set or perform a variety of functions, and operates a corresponding appliance by transmitting a control command corresponding to a key manipulated by a user. In general, the remote controller has a long shape such that a user can press a desired key by holding it in one hand.

If a user uses separate remote controllers for various appliances, the user must spend a great amount of money and be burdened with the maintenance and management of the remote controllers according to the appliances.

In this regard, a remote controller available for a plurality of appliances has been developed. For instance, a remote controller capable of operating an optical disc player as well as a television has been developed.

Meanwhile, a remote controller for a video game unit allows a user to power on and/or off the video game unit and set or execute provided functions. Such a remote controller for the video game unit allows a user to use the remote controller with both hands based on the characteristics of the video game unit.

As described above, remote controllers may be classified into a one-hand mode and a two-hand mode according to the characteristics of various appliances. If a user employs remote controllers for all modes, the user may be burdened with extraneous costs and maintenance. For this reason, a multi-function remote controller that can be integrally used regardless of a mode type has been required.

U.S. Patent Publication No. 2006-158342 discloses an integrated remote controller that is used for an A/V device (i.e., a television (TV), a video cassette recorder (VCR), a DVD player, etc.), and can be used as a video game controller when the integrated remote controller is horizontally positioned. In this publication, the integrated remote controller is upright in a longitudinal direction such that a user can hold the remote controller with one hand when adjusting a TV, and rotated in a transverse direction such that the user can hold the remote controller with both hands in order to play a video game. Further, in the publication, a plurality of buttons is provided in order to individually set a mode type. For example, several buttons are used corresponding to a TV mode, a CD mode, a VCR mode, a Game mode. In addition, the remote controller independently employs light emitting diodes (LEDs) to transmit a signal of the remote controller in the vertically upright position and in the horizontal position.

As described above, since the conventional remote controller must have an individual component to select a corresponding mode and transmit a signal in the selected mode according a one-hand mode or a both-hand mode, the manufacturing cost may be increased, or the number of manufacturing processes may be increased.

### SUMMARY OF THE INVENTION

The present general inventive concept provides a multi-function remote controller and a method of controlling the same, capable of simplifying components of the multi-function remote controller when realizing the multi-function remote controller to support one-hand and two-hand modes.

Additional aspects and/or utilities of the present general inventive concept will be set forth in part in the description which follows and, in part, will be apparent from the description, or may be learned by practice of the general inventive concept.

The foregoing and/or other aspects and utilities of the present general inventive concept are achieved by providing a remote controller including a key section equipped with a plurality of keys used to operate an appliance to be controlled, a body provided with the keys, a transmitter to wirelessly transmit control signals corresponding to the keys, in which a position of the transmitter is changeable in the body, and a controller which sets one of operational modes according to the position of the transmitter and outputs the control signals corresponding to the keys through the transmitter according to the set operational mode.

The transmitter may be installed in one of first and second positions, in which the first position corresponds to a first mode allowing a user to operate the body with one hand, and the second position corresponds to a second mode allowing the user to operate the body with two hands.

The transmitter may be positioned in line with the body in the first position, and rotated with respect to the body at a predetermined angle in the second position.

The transmitter may include a rotatable lever rotatably installed in the body, and an infrared diode installed in one side of the rotatable lever to transmit an infrared signal.

The transmitter may further include a hinge shaft used to hinge the rotatable lever to the body.

The remote controller may further include a mode selecting switch to provide a signal corresponding to the operational mode set according to the position of the transmitter to the controller, in which the controller recognizes the operational modes according to an on-state or an off-state of the mode selecting switch.

The transmitter may be provided at a first side with a protrusion, in which the protrusion makes contact with the mode selecting switch according to the position of the transmitter.

The controller may match two different control commands to the keys, and may output a corresponding control command according to the set operational mode.

The keys of the key section may include an enter key which powers on/off the appliance, sets or executes a predetermined function corresponding to the appliance, and at least one functional key which selects functions corresponding to the appliance.

When a plurality of enter keys are provided in the body, the enter keys may perform a same function in each operational mode, and may be installed at different positions in the body.

The foregoing and/or other aspects and utilities of the present general inventive concept may also be achieved by providing a method of controlling a remote controller having a body provided with a plurality of keys that operate an appliance to be controlled and a transmitter that wirelessly transmits control signals corresponding to the keys, including setting one of a plurality of operational modes by changing an installation position of the transmitter in the body, determining a key manipulated by a user among the keys in the operational mode, and transmitting a control signal corresponding to the manipulated key through the transmitter.

The operational mode may be set as one of first and second modes, in which the first mode represents that the transmitter is positioned in line with the body so that a user operates the body with one hand, and the second mode represents that the transmitter is rotated with respect to the body at a predetermined angle so that the user operates the body with two hands.

When transmitting the control signal, a corresponding control command is output according to the set operational mode if at least two different control commands are matched to the plurality of keys.

The foregoing and/or other aspects and utilities of the present general inventive concept may also be achieved by providing a remote controller including a body to operate a plurality of appliances, the remote controller including a plurality of keys to operate one of the plurality of appliances based on a set operational mode to generate a corresponding signal, a transmitter movably coupled to the body to transmit the signal to the one of the plurality of appliances based on the set operational mode, and a controller to set the operational mode based on a rotated position of the transmitter.

The may further include a switch to allow the controller to alternate between a first operational mode and a second operational mode.

The transmitter may further include a protrusion to not contact the switch to activate the first operational mode when the transmitter is in a first rotated position and to depress the switch to activate the second operational mode when the transmitter is in a second rotated position.

The first operational mode may be a one-handed operational mode and the second operational mode may be a two-handed operational mode.

The foregoing and/or other aspects and utilities of the present general inventive concept may also be achieved by providing a method of controlling a remote controller having a body with a plurality of keys to operate a plurality of appliances, and a rotatable transmitter to wirelessly transmit control signals corresponding to the plurality of keys, the method including setting one of a plurality of operational modes by rotating the transmitter to a particular position, and transmitting a control signal to a corresponding one of the appliances according to the set operational mode through the transmitter if one of the plurality of keys is depressed.

The method may further include depressing a switch with a portion of the transmitter to alternate between the operational modes when the transmitter is rotated.

A first operational mode of the plurality of operational modes may be a one-handed operational mode, and a second operational mode of the plurality of operational modes may be a two-handed operational mode.

The foregoing and/or other aspects and utilities of the present general inventive concept may also be achieved by providing a remote controller, including a plurality of keys to generate a first signal and a second signal, and a transmitter to move between a first position and a second position to transmit the first signal and the second signal in a first direction and a second direction with respect to positions of keys.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A is a view to illustrate an example in which a user uses a multi-function remote controller with one hand according to an embodiment of the present general inventive concept;

FIG. 1B is a view to illustrate an example in which a user uses the multi-function remote controller with two hands according to an embodiment of the present general inventive concept;

FIG. 2 is a perspective view illustrating a transmitter of a multi-function remote controller according to an embodiment of the present general inventive concept;

FIG. 3 is a view illustrating a transmitter of a multi-function remote controller according to an embodiment of the present general inventive concept;

FIG. 4 is a block diagram illustrating a controller of a multi-function remote controller according to an embodiment of the present general inventive concept;

FIG. 5 is a table illustrating infrared codes matched to functional keys in a first mode corresponding to one-hand use and a second mode corresponding to two-hand use in a multi-function remote controller according to an embodiment of the present general inventive concept; and

FIG. 6 is a flowchart illustrating a method of controlling a multi-function remote controller according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

Hereinafter, a multi-function remote controller 100 and a method of controlling the same according to an embodiment of the present general inventive concept will be described.

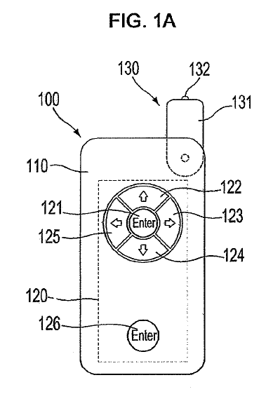

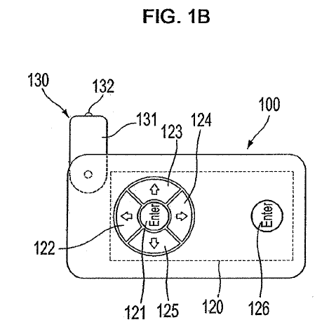

FIG. 1A is a view to illustrate an example in which a user uses the multi-function remote controller 100 with one hand, and FIG. 1B is a view to illustrate an example in which a user uses the multi-function remote controller 100 with two hands.

As illustrated in FIGS. 1A and 1B, the multi-function remote controller 100 includes a body 110, a key section 120, and a transmitter 130.

The body 110 has a rectangle-shaped external appearance.

The body 110 is provided on the front surface thereof with the key section 120 that may be manipulated by a user, and provided at the first side thereof with the transmitter 130 that is rotatable.

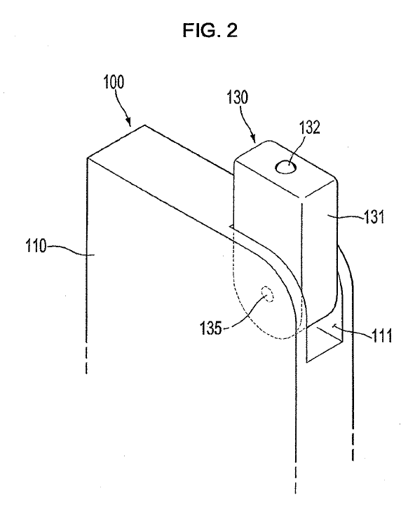

As illustrated in FIG. 2, the transmitter 130 includes a rotatable lever 131 that is hinged to a hinge shaft 135 of the body 110 and an infrared diode 132 installed at a first side of the rotatable lever 131 to transmit an infrared signal in a forward direction. The rotatable lever 131 is rotatably installed in a groove 111.

Referring again to FIGS. 1A and 1B, the key section 120 includes first and second enter keys 121 and 126 used to set a power-on or power-off command and execution commands corresponding to appliance to be controlled, and also includes a plurality of functional keys 122, 123, 124, and 125 arranged around a circumference of the first enter key 121.

Although the first and second enter keys 121 and 126 are arranged at different positions on the front surface of the body 110, both the first and second enter keys 121 and 126 may be manipulated by a user and equipped with the same function.

The plurality of functional keys 122, 123, 124, and 125 may have different functions with respect to the appliance according to operational mode types that include an operational mode (hereinafter, referred to as “first mode”) allowing one-hand use as illustrated in FIG. 1A and an operational mode (hereinafter, referred to as “second mode”) allowing two-hand use as illustrated in FIG. 1B.

The selection between the first and second modes is determined according to the position of the transmitter 130.

As illustrated in FIG. 1A, the first mode represents a state in which the transmitter 130 is positioned in line with the body 10 while facing the appliance. In the first mode, a user can easily hold the body 110 and manipulate the plurality of keys 121 through 126 using one hand.

As illustrated in FIG. 1B, the second mode represents a state in which the transmitter 130 is positioned toward the appliance and rotated with respect to the body 110 at a predetermined angle. In the second mode, a user can easily hold the body 110 to manipulate the plurality of keys 121-126 using two hands.

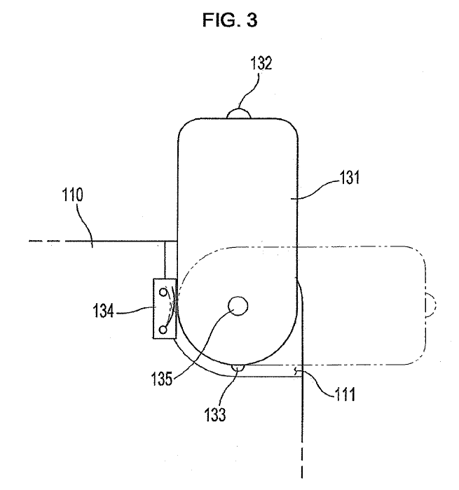

In the first mode, the transmitter 130 is positioned in line with the body 110 as described above, and a protrusion 133 formed at the first side of the rotatable lever 131 does not make contact with a mode selecting switch 134 as illustrated in FIG. 3. In this case, the mode selecting switch 134 is in an off-state.

If a user turns the rotatable lever 131 in order to switch the first mode to the second mode, the transmitter 130 is rotated with respect to the body 110 at a predetermined angle as marked with a virtual line. At this time, the protrusion 133 of the rotatable lever 131 makes contact with the mode selection switch 143, thereby turning on the mode selecting switch 134.

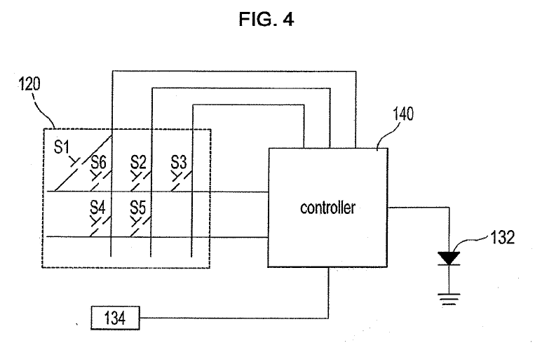

As illustrated in FIG. 4, the mode selection switch 134 is electrically connected to an input terminal of a controller 140 to control the operation of the remote controller 100.

The mode selecting switch 134 provides an on and/or off signal to the controller 140, and the controller 140 can determine based on the on and/or off signal from the mode selecting switch 134 whether the position of the transmitter 130 corresponds to the first mode or the second mode.

The key section 120 is connected to the input terminal of the controller 140.

First through sixth switches S1 through S6 corresponding to the plural keys 121 through 126 of the key section 120 are electrically connected to the controller 140, and a corresponding switch is turned on and/or off according to the manipulation of one of the corresponding keys 121 through 126. In this case, the first and second enter keys 121 and 126 correspond to the first and sixth switches S1 and S6, respectively, and the plurality functional keys 122, 123, 124, and 125 correspond to the second through fifth switches S2, S3, S4, and S5, respectively.

The first and second enter keys 121 and 126 are used to power on and/or off the appliance or set and execute the functions of the appliance. The first enter key 121 may be used in the first mode when a user manipulates the remote controller 100 with one hand, and the second enter key 126 may be used in the second mode when a user manipulates the remote controller 100 with two hands.

As described above, the functional keys 122 to 125 are provided such that functions given to a corresponding appliance to be controlled can be set. In general, the functional keys 122 to 125 are used to manipulate a graphic user interface (GUI), which is used to set functions based on guide information displayed on a display device (not illustrated) provided in the appliance.

The first mode (one-handed mode) is employed when a user manipulates the remote controller 100 with respect to a household appliance (e.g., a TV, an optical disc player, etc.). In the first mode, the first functional key 122 may correspond to a set command (Up) to move a cursor upward, and the second functional key 123 may correspond to a set command (Right) to move the cursor rightward. In addition, the third functional key 124 may correspond to a set command (Down) to move the cursor downward, and the fourth functional key 125 may correspond to a set command (Left) to move the cursor leftward.

Since the second mode (two-handed mode) is employed when a user manipulates the remote controller 100 to be used with a video game appliance, set information corresponding to the plurality of functions is different from that in the first mode. For example, in the second mode, the first functional key 122 may correspond to a set command (Left) to move a cursor leftward, and the second functional key 123 may correspond to a set command (Up) to move the cursor upward. In addition, the third functional key 124 may correspond to a set command (Right) to move the cursor rightward, and the fourth functional key 125 may correspond to a set command (Down) to move the cursor downward.

The controller 140 can determine whether an operational mode set according to an on and/or off state of the mode selecting switch 134 is the first mode or the second mode, and recognize set information about a corresponding key according to on and/or off states of the functional keys 121 through 126 in the set operational mode.

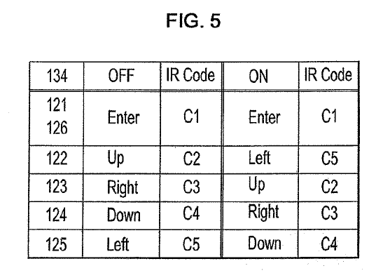

As illustrated in FIG. 5, the controller 140 searches to find information about infrared codes C1 through C5 corresponding to keys manipulated by a user in an internal memory, and outputs a control signal corresponding to the infrared codes C1 through C5 such that the infrared diode 132 wirelessly transmits a control command corresponding to the infrared codes C1 through C5.

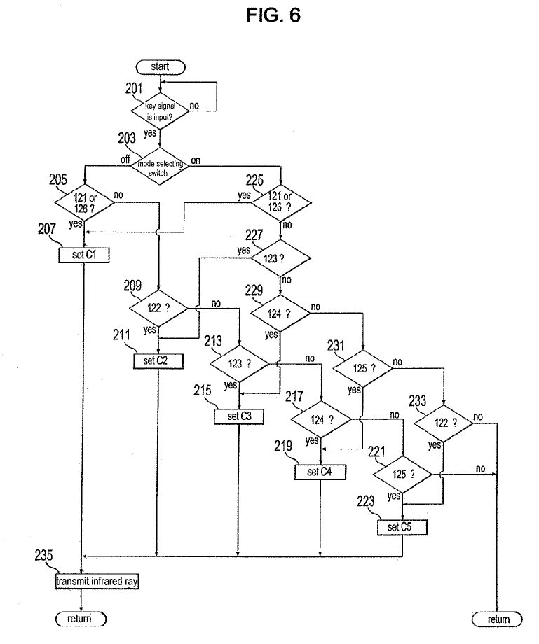

Hereinafter, a method of controlling a multi-function remote controller according to an embodiment of the present general inventive concept will be described with reference to FIG. 6.

The controller 140 determines the input of a key signal in operation 201. If the key signal is input, the controller 140 determines an on and/or off state of the mode selecting switch 134 in operation 203.

If the mode selecting switch 134 is in an off state in operation 203, that is, if the remote controller is in the first mode, in which the transmitter 130 is in line with the body 110 as illustrated in FIG. 1A such that a user can handle the remote controller using one hand, the controller 140 determines whether the first enter key 121 or the second enter key 126 is manipulated in operation 205. If the first enter key 121 or the second enter key 126 is manipulated, the manipulated enter key is set as the first code C1 in operation 207.

If the first enter key 121 or the second enter key 126 is not manipulated in operation 205, the controller 140 determines if the first functional key 122 is manipulated in operation 209. If the first functional key 122 is manipulated, the first functional key 122 is set as the second code C2 in operation 211.

If the first functional key 122 is not manipulated in operation 209, the controller 140 determines if the second functional key 123 is manipulated in operation 213. If the second functional key 123 is manipulated, the second functional key is set as the second code C3 in operation 215.

If the second functional key 123 is not manipulated in operation 213, the controller 140 determines if the third functional key 124 is manipulated in operation 217. If the third functional key 124 is manipulated, the third functional key is set as the third code C4 in operation 219.

If the third functional key 124 is not manipulated in operation 217, the controller 140 determines if the fourth functional key 125 is manipulated in operation 221. If the fourth functional key 125 is manipulated, the fourth functional key is set as the fifth code C5 in operation 223.

If the mode selecting switch 134 is in an on state in operation 203, that is, if the remote controller is in the second mode, in which the transmitter 130 is rotated with respect to the body 110 at a predetermined angle as illustrated in FIG. 1B such that a user can handle the remote controller using two hands, the controller 140 determines whether the first enter key 121 or the second enter key 126 is manipulated in operation 225. If the first enter key 121 or the second enter key 126 is manipulated, the manipulated enter key is set as the first code C1 in operation 207.

If the first enter key 121 or the second enter key 126 is not manipulated in operation 225, the controller 140 determines if the second functional key 123 is manipulated in operation 227. If the second functional key 123 is manipulated, the second functional key 123 is set as the second code C2 in operation 211.

If the second functional key 123 is not manipulated in operation 227, the controller 140 determines if the third functional key 124 is manipulated in operation 229. If the third functional key 124 is manipulated, the third functional key 124 is set as the second code C3 in operation 215.

If the third functional key 124 is not manipulated in operation 229, the controller 140 determines if the fourth functional key 125 is manipulated in operation 231). If the fourth functional key 125 is manipulated, the fourth functional key 125 is set the fourth code C4 in operation 219.

If the fourth functional key 125 is not manipulated in operation 231, the controller 140 determines if the first functional key 122 is manipulated in operation 233. If the first functional key 122 is manipulated, the first functional key 122 is set the fifth code C5 in operation 223.

The controller 140 outputs a control signal according to the infrared codes set in the above operations 207, 211, 215, 219, and 223, and the infrared diode 132 of the transmitter 130 wirelessly transmits an infrared signal corresponding to a control code to an appliance to be controlled in operation 235. Accordingly, the appliance operates to perform a function corresponding according to the transmitted infrared signal.

As described above, according to the present general inventive concept, a one-hand use mode or a two-hand use mode is selected by rotating a transmitter that transmits a control command to an appliance, and a single transmitter is used regardless of a mode type to transmit a signal to the appliance. Accordingly, unlike the related art, components corresponding to mode selection and signal transmission can be reduced, thereby reducing manufacturing costs and a number of manufacturing processes.

Although few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A remote controller, comprising:
a key section equipped with a plurality of keys to operate and control an appliance;
a body including the keys;
a transmitter to wirelessly transmit control signals corresponding to the keys, in which a position of the transmitter is changeable in the body; and
a controller to set one of operational modes according to the position of the transmitter and to output the control signals corresponding to the keys through the transmitter according to the set operational mode.

2. The remote controller of claim 1, wherein:
the transmitter is installed in one of first and second positions;
the first position corresponds to a first mode allowing a user to operate the body with one hand and
the second position corresponds to a second mode allowing the user to operate the body with two hands.

3. The remote controller of claim 1, wherein:
the transmitter is positioned in line with the body in a first position; and
the transmitter is rotated with respect to the body at a predetermined angle in a second position.

4. The remote controller of claim 1, wherein the transmitter comprises:
a rotatable lever rotatably installed in the body; and
an infrared diode installed in one side of the rotatable lever to transmit an infrared signal.

5. The remote controller of claim 1, wherein the transmitter further comprises:
a hinge shaft to hingeably attach the rotatable lever to the body.

6. The remote controller of claim 1, further comprising:
a mode selecting switch to provide a signal corresponding to the operational mode set according to the position of the transmitter to the controller, in which the controller recognizes the operational modes according to an on-state or an off-state of the mode selecting switch.

7. The remote controller of claim 6, wherein the transmitter is provided at a first side with a protrusion, in which the protrusion makes contact with the mode selecting switch according to the position of the transmitter.

8. The remote controller of claim 1, wherein:
the controller matches two different control commands to the keys; and
the controller outputs a corresponding control command according to the set operational mode.

9. The remote controller of claim 1, wherein the keys of the key section comprise:
an enter key to power on and/or off the appliance, and to set or execute a predetermined function corresponding to the appliance; and
at least one functional key to select functions corresponding to the appliance.

10. The remote controller of claim 1, wherein:
a plurality of enter keys are provided in the body, the enter keys perform a same function in each operational mode, and are installed at different positions in the body.

11. A method of controlling a remote controller having a body provided with a plurality of keys that operates an appliance to be controlled and a transmitter that wirelessly transmits control signals corresponding to the keys, the method comprising:
setting one of a plurality of operational modes by changing an installation position of the transmitter in the body;
determining a key manipulated by a user among the keys in the operational mode; and
transmitting a control signal corresponding to the manipulated key through the transmitter.

12. The method of claim 11, wherein:
the operational mode is set as one of first and second modes;
the first mode represents that the transmitter is positioned in line with the body to allow a user to operate the body with one hand; and
the second mode represents that the transmitter is rotated with respect to the body at a predetermined angle to allow the user to operate the body with two hands.

13. The method of claim 11, wherein, in the step of transmitting the control signal, a corresponding control command is output according to the set operational mode if at least two different control commands are matched to the plurality of keys.

14. A remote controller including a body to operate a plurality of appliances, the remote controller comprising:
a plurality of keys to operate one of the plurality of appliances based on a set operational mode to generate a corresponding signal;
a transmitter rotatably coupled to the body to transmit the signal to the one of the plurality of appliances based on the set operational mode; and
a controller to set the operational mode based on a rotated position of the transmitter.

15. The remote controller of claim 14, further comprising:
a switch to allow the controller to alternate between a first operational mode and a second operational mode.

16. The remote controller of claim 15, wherein the transmitter further comprises:
a protrusion to not contact the switch to activate the first operational mode when the transmitter is in a first rotated position and to depress the switch to activate the second operational mode when the transmitter is in a second rotated position.

17. The remote controller of claim 16, wherein the first operational mode is a one-handed operational mode and the second operational mode is a two-handed operational mode.

18. A method of controlling a remote controller having a body with a plurality of keys to operate a plurality of appliances, and a rotatable transmitter to wirelessly transmit control signals corresponding to the plurality of keys, the method comprising:
setting one of a plurality of operational modes by rotating the transmitter to a particular position; and
transmitting a control signal to a corresponding one of the appliances according to the set operational mode through the transmitter if one of the plurality of keys is depressed.

19. The method of claim 18, further comprising:
depressing a switch with a portion of the transmitter to alternate between the operational modes when the transmitter is rotated.

20. The method of claim 18, wherein:
a first operational mode of the plurality of operational modes is a one-handed operational mode; and
a second operational mode of the plurality of operational modes is a two-handed operational mode.
